(19) United States
(12) Patent Application Publication
(10) Pub. No.: US 2015/0227958 A1
(43) Pub. Date: Aug. 13, 2015

(54) SETTLEMENT TERMINAL AND METHOD FOR THE SAME

(71) Applicant: TOSHIBA TEC KABUSHIKI KAISHA, Tokyo (JP)

(72) Inventor: Hiroki Yamada, Kawazu (JP)

(21) Appl. No.: 14/614,533

(22) Filed: Feb. 5, 2015

(30) Foreign Application Priority Data
Feb. 10, 2014 (JP) 2014-023620

(51) Int. Cl. G06Q 30/02

(52) U.S. Cl. CPC G06Q 30/0233

(57) ABSTRACT

A settlement terminal comprises a reading module for reading information stored in a storage medium held by a customer; a settlement module for executing settlement processing based on settlement information read by the reading module; a point granting module for adding points corresponding to a settlement amount to a cumulative value associated with the identification information read by the reading module, within point management data in which the identification information for identifying each storage medium and the cumulative value of points granted for the identification information are associated with each other, to grant the points; a point use module for subtracting the instructed point from the cumulative value associated with the identification information read by the reading module to use the points in a pre-determined service; and a provision module for providing an operation screen for continuously executing the use and the granting of points in a series of operations.

### CROSS-REFERENCE TO RELATED APPLICATION

This application is based upon and claims the benefit of priority from Japanese Patent Application No. 2014-023620, filed Feb. 10, 2014, the entire contents of which are incorporated herein by reference.

### FIELD

Embodiments described herein relate generally to a settlement terminal and a method for the settlement terminal.

### BACKGROUND

Conventionally, the data (settlement information) which is stored in a medium such as an IC card and the like and can be used in a commodity transaction is used to carryout settlement (electronic settlement) of a commodity. In such a settlement, it is possible to carry out the settlement by presenting the IC card and the like, thus, there is a settlement terminal dedicated for electronic settlement.

Further, conventionally, a point service system for granting points corresponding to the purchase amount of the commodity is used in a store and the like. In such a point service system, for example, a point card is distributed to a customer who is a member, and the points granted corresponding to the purchase amount are cumulatively stored in association with the point card. The granted points can be used for discount corresponding to the amount of the points or exchanging a commodity in the following transaction.

There is provided a service in which the electronic settlement and the point service are combined. In a case of providing such a service, it is efficient to carry out the processing relating to the use and the granting of points by the settlement terminal dedicated for electronic settlement, instead of using the POS (Point Of Sales) terminal. Thus, there is a need for a technology which can carry out the processing relating to the use and the granting of points efficiently in the settlement terminal dedicated for electronic settlement.

### BRIEF DESCRIPTION OF THE DRAWINGS

FIG. 1 is a diagram illustrating the constitution of a POS system according to one embodiment;

FIG. 2 is a diagram illustrating an example of the data arrangement of a point DB;

FIG. 3 is a diagram illustrating the appearance of a settlement terminal;

FIG. 4 is a block diagram illustrating the hardware constitution of the settlement terminal;

FIG. 5 is a diagram illustrating the functional components of the settlement terminal;

FIG. 6 is a flowchart illustrating an example of the procedure of point processing executed by a control section of the settlement terminal;

FIG. 7 is a diagram illustrating an example of a point use screen;

FIG. 8 is a diagram illustrating an example of a confirmation screen; and

FIG. 9 is a diagram illustrating an example of a point granting screen.

### DETAILED DESCRIPTION

In accordance with one embodiment, a settlement terminal comprises a reading module, a settlement module, a point granting module, a point use module and a provision module. The reading module reads information stored in a storage medium held by a customer. The settlement module carries out settlement processing based on settlement information read by the reading module. The point granting module adds points corresponding to a settlement amount to a cumulative value associated with the identification information read by the reading module, within point management data in which the identification information for identifying each storage medium and the cumulative value of points granted for the identification information are associated with each other, to grant the points. The point use module subtracts the instructed point from the cumulative value associated with the identification information read by the reading module to use the points in a pre-determined service. The provision module provides an operation screen for continuously executing the use and the granting of points in a series of operations.

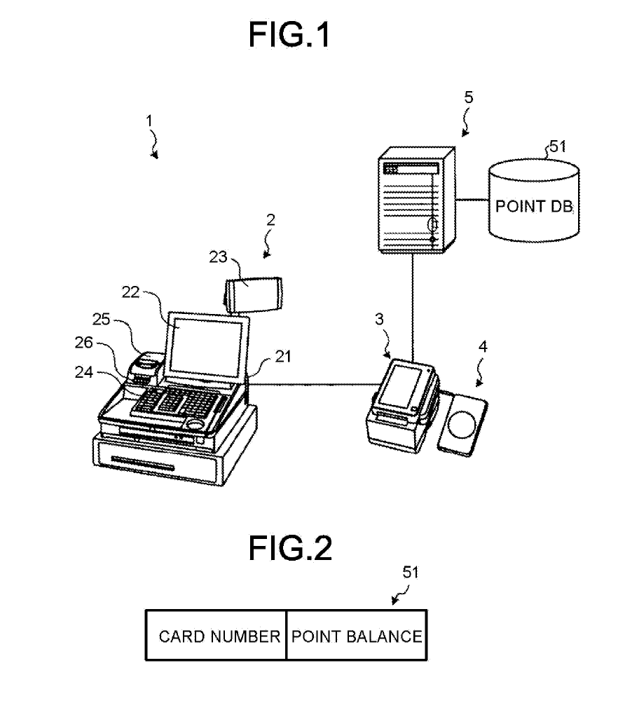

FIG. 1 is a diagram illustrating the constitution of a POS system 1 according to the present embodiment.

As shown in FIG. 1, the POS system 1 includes a POS terminal 2, a settlement terminal 3 and a point management server 5. The POS terminal 2, the settlement terminal 3 and the point management server 5 are connected with one another to be capable of carrying out communication in a wired or wireless manner. The settlement terminal 3 is connected with a reader device 4 to be capable of carrying out communication in a wired or wireless manner.

The POS terminal 2, which is a device for carrying out commodity sales data processing for commodities purchased by a customer, carries out settlement processing of one transaction. In a case of carrying out settlement (electronic settlement) using a magnetic card or an IC card and the like, the POS terminal 2 carries out settlement processing of one transaction through the cooperation with settlement terminal 3. The electronic settlement includes credit settlement using a credit card, immediate settlement using a debit card and the like, prepaid type or post-pay type electronic money settlement and the like.

As shown in FIG. 1, a display section 22 for shop clerk and a display section 23 for customer are arranged at the upper portion of a main body 21 of the POS terminal 2. Each display section 22 and 23, which is a LCD (Liquid Crystal Display) or a device formed by arranging a touch panel on the surface of a LCD, displays a commodity name, a commodity amount, a total amount of one transaction and the like.

At the upper surface of the main body 21 is arranged a keyboard 24 provided with a cash settlement key, a credit settlement key and the like for selecting a settlement method such as cash settlement or credit settlement and the like.

At the inside of the main body 21 is arranged a printer 25 for printing a receipt and the like. The receipt paper printed by the printer 25 is discharged from a receipt issuing port 26 arranged at the upper portion of the main body 21.

The settlement terminal 3 is a dedicated electronic settlement terminal. The settlement terminal 3 reads settlement information for electronic settlement to be used in a commodity transaction from a storage medium (hereinafter referred to as a settlement card) such as a magnetic card or an IC card for electronic settlement and the like. The settlement terminal 3 carries out communication with a server device and the like (not shown) of a card company to carry out settlement processing using the settlement information. The settlement terminal 3 further reads card number from a storage medium (hereinafter referred to as a point card) such as a magnetic card or an IC card for point management and the like, and carries out communication with the point management server 5 to execute point processing such as the use or granting of points.

The point card is distributed to each customer who uses the present system in advance. The card number, which is identification information for identifying each point card, is assigned with unique numeric. The settlement card may store the card number together with the settlement information to achieve functions of a point card. The unique identification information stored in the settlement card may be used as the card number.

The reader device 4 functions as a reading module under the control of the settlement terminal 3 (control section 100).

The reader device 4 accesses a contactless-type IC card using a near field communication technology such as a NFC (Near Field Communication) and the like to read the information stored in the IC card.

In the present embodiment, the reader device 4 reads the settlement information and the card number from the settlement card and the point card under the control of the settlement terminal 3 (control section 100), and sends them to the settlement terminal 3.

The settlement terminal 3 and the reader device 4 are arranged separately from each other in the present embodiment; however, they may be arranged integrally by providing the settlement terminal 3 with the functions of the reader device 4.

The point management server 5 manages the points granted to each customer. The point management server 5 includes a point DB 51 for storing and managing the points of each customer. The point DB 51 stores the points in such a manner that the points can be referred to from the settlement terminal 3.

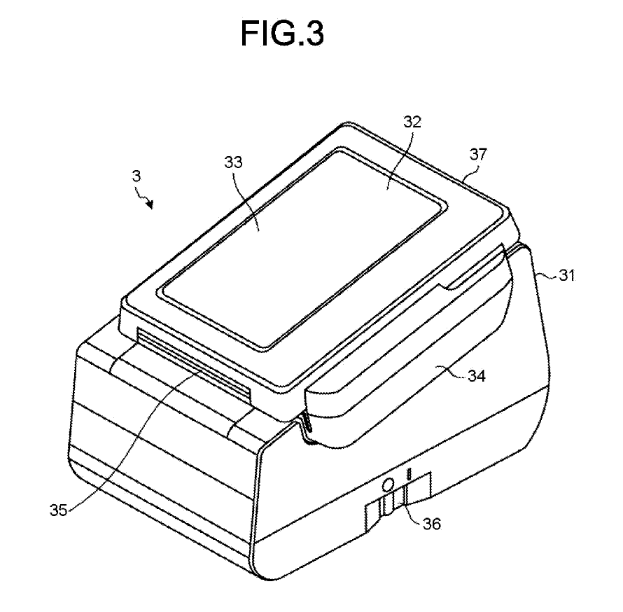

FIG. 2 is a diagram illustrating an example of the data arrangement of the point DB 51. As shown in FIG. 2, the point DB 51 stores the card number assigned to each point card and point balance indicating a cumulative value of the points in an associated manner.

Further, the information stored in the point DB 51 is not limited to the example shown in FIG. 2. For example, point usage history and the like may also be stored in an association manner.

The point management server 5 subtracts, if receiving a point subtraction instruction in which a specific card number is designated from the settlement terminal 3, a designated amount of points from the point balance of a point card specified with the card number.

The point management server 5 adds, if receiving a point adding instruction in which a specific card number is designated from the settlement terminal 3 (control section 100), a designated amount of points to the point balance of a point card specified with the card number.

Next, the settlement terminal 3 is described in detail.

FIG. 3 is a diagram illustrating the appearance of the settlement terminal 3. In FIG. 3, a power source switch 36 is arranged at the lateral side of a main body 31 of the settlement terminal 3. An upper surface panel 37 which can be opened and closed with respect to the main body 31 is arranged at the upper portion of the main body 31. The upper surface panel 37 can be opened to set roll shape receipt paper into the inside of the main body 31. At the surface of the upper surface panel 37 is arranged a display section 32 at the surface of which is arranged a touch panel serving as an operation section 33.

At the upper lateral surface of the main body 31 is arranged a card reading section 34 which reads the information stored in the magnetic card such as the settlement card or the point card and the like.

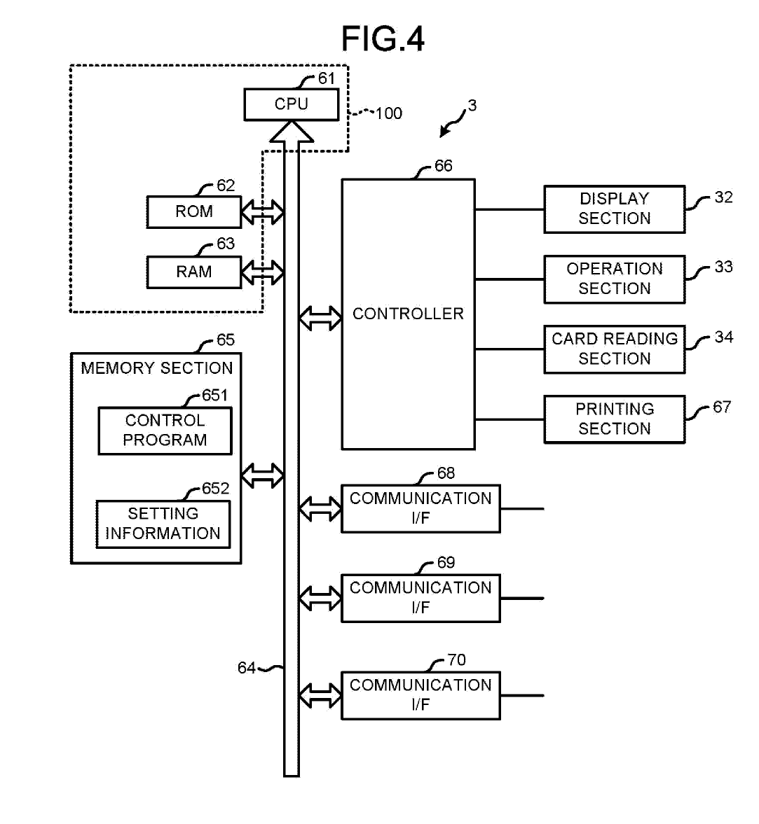

At the inside of the main body 31 is arranged a printing section 67 (refer to FIG. 4) which prints sales report or information relating to the settlement on the receipt paper. The printed receipt paper is discharged from a receipt issuing port 35 arranged between the main body 31 and the upper surface panel 37.

FIG. 4 is a block diagram illustrating the hardware constitution of the settlement terminal 3. As shown in FIG. 4, the settlement terminal 3 includes the control section 100 for controlling each section. The control section 100 is constituted by connecting a CPU (Central Processing Unit) 61 for controlling each section with a ROM (Read Only Memory) 62 and a RAM (Random Access Memory) 63 through a bus line 64 such as an address bus, a data bus and the like.

The control section 100 is connected with a memory section 65 and a controller 66 through the bus line 64. The control section 100 executes various processing by the CPU 61 which operates according to a control program 651 stored in the memory section 65 and copied or decompressed on the RAM 63.

The memory section 65, which is a nonvolatile memory such as a flash memory and the like for holding the stored information even if the power source is turned off, stores programs including the control program 651.

The memory section 65 further stores setting information 652 for setting a point granting rate serving as a standard for calculating the points to be granted, and the like.

The point granting rate is used for determining the granting rate in a case of granting points; for example, one point is granted for each payment amount of 100 YEN.

The controller 66 is further connected with the display section 32 and the operation section 33. The controller 66 executes various controls based on the instructions from the control section 100.

The display section 32 displays various kinds of information such as a key image, an operation screen (GUI) and the like. The operation section 33 serving as a touch panel arranged on the display section 32 executes, if touched at a position corresponding to the key displayed on the display section 32, various key operations.

The controller 66 is connected with the printing section 67 and the card reading section 34. The printing section 67 draws out the front end of the receipt paper set inside the main body 31 and prints the settlement information and the like on the receipt paper by, for example, a thermal head.

The card reading section 34 functions as a reading module under the control of the control section 100. The card reading section 34 reads the settlement information and the card information stored in the settlement card and the point card.

The bus line 64 is connected with communication I/Fs (Interfaces) 68, 69 and 70. The communication I/F 68 is connected with the POS terminal 2. The communication I/F 69 is connected with the reader device 4. The communication I/F 70 is connected with the point management server 5.

The settlement terminal 3 carries out information transmission/reception with the POS terminal 2, the reader device 4 and the point management server 5 through each communication I/F 68, 69 and 70.

Next, the functional components of the settlement terminal 3 are described.

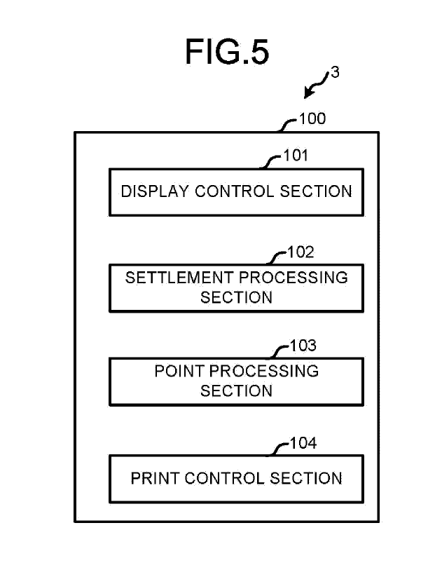

FIG. 5 is a diagram illustrating the functional components of the settlement terminal 3.

The settlement terminal 3 realizes function sections such as a display control section 101, a settlement processing section 102, a point processing section 103, a print control section 104 and the like by the control section 100 (CPU 61) which operates according to programs such as the control program 651 stored in the memory section 65.

The display control section 101 controls the display output to the display section 32. The display control section 101 cooperates with other function sections to display various operation screens (GUI) relating to the use and granting of the points and the settlement work on the display section 32. The display control section 101 further displays a software keyboard for inputting various kinds of information.

The settlement processing section 102 functions as a settlement module. The settlement processing section 102 carries out settlement processing (electronic settlement) based on the settlement information read by the card reading section 34 or the reader device 4. The settlement processing section 102 copes with a plurality of settlement methods through, for example, the cooperation with the POS terminal 2. In this way, in a case in which the amount paid in the settlement by the first settlement method (for example, prepaid type electronic money) is less than the payment amount (settlement amount) the customer should pay in one transaction, the settlement processing section 102 can carry out settlement using other settlement method (for example, credit card). The settlement method is a well-known/commonly used technology, thus, the detailed description thereof is not provided.

The point processing section 103 functions as a point granting module and a point use module. The point processing section 103 further functions as a provision module through the cooperation with the display control section 101.

The point processing section 103 executes processing relating to the use of points and the granting of points based on the card number read by the card reading section 34 or the reader device 4. The point processing section 103 further reads the point balance corresponding to the card number from the point DB 51 and displays the point balance on the display section 32.

The point processing section 103, if receiving a point using instruction through the operation section 33, determines whether or not the point value (hereinafter referred to as used point), that is, the amount of the points to be used is lower than the point balance.

In a case in which the used point is lower than the point balance, the point processing section 103 instructs the settlement module to subtract an amount corresponding to the used point from the payment amount. Then the point processing section 103 sends instruction information instructing the subtraction of the used point amount together with the card number to the point management server 5 to instruct the subtraction of the used point amount from the point balance.

The point processing section 103, if receiving an instruction operation instructing the granting of points through the operation section 33, calculates the value (hereinafter referred to as added point) of the points to be granted based on the settlement amount in the transaction and the point granting rate stored in the setting information 652. Then the point processing section 103 sends instruction information instructing the adding of the added point amount together with the card number to the point management server 5 to instruct the adding of the added point amount to the point balance.

The point processing section 103 executes the processing relating to the use and the granting of points continuously in a series of operations.

The continuous execution does not mean that an operator operates switches to switch between and execute the use and the granting of points, but means sequential execution in the point processing having a series of screen transitions. The point processing is described later.

The print control section 104 controls the printing section 67 to print the information relating to the use and the granting of points and the content of the settlement and the like on the receipt paper.

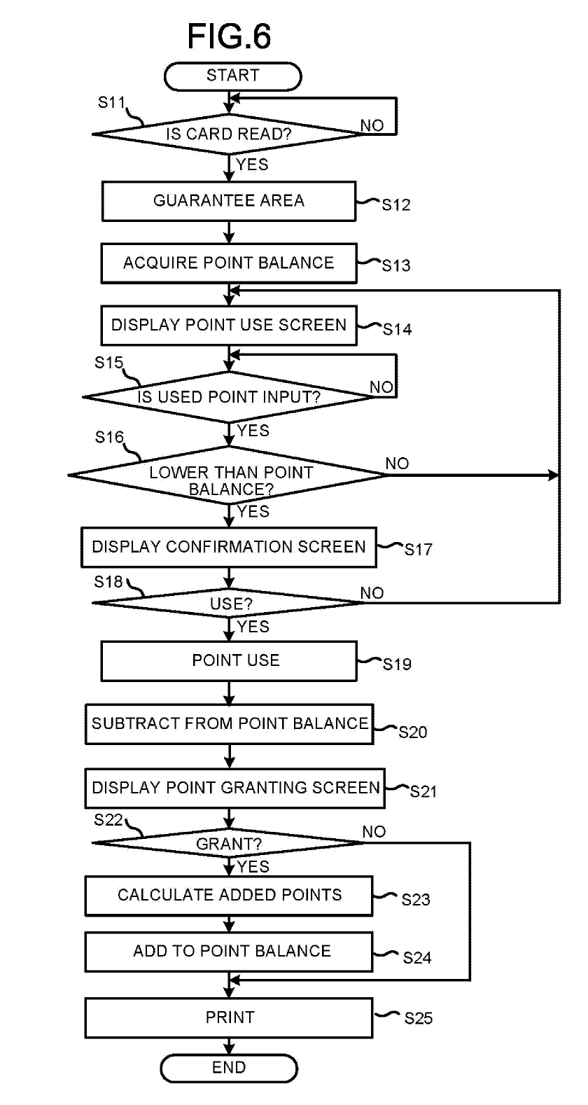

Hereinafter, the operations of the settlement terminal 3 are described with reference to FIG. 6-FIG. 9.

FIG. 6 is a flowchart illustrating an example of the procedure of the point processing executed by the control section 100 (CPU 61) of the settlement terminal 3.

The point processing is executed when the settlement processing section 102 carries out settlement processing.

In a case in which a plurality of settlement methods is used in one transaction, the point processing is executed for each settlement method.

First, the point processing section 103 waits until the point card is read in the card reading section 34 or the reader device 4 (NO in ACT S11). After the point card is read (YES in ACT S11), the point processing section 103 guarantees an area in the RAM 63 for temporarily storing the data (transaction) relating to the use and the granting of points (ACT S12).

Next, the point processing section 103 carries out the query of the point balance in the point management server 5 based on the card number read from the point card to acquire the point balance (ACT S13).

The point processing section 103, after acquiring the point balance, displays a point use screen for inputting the used points on the display section 32 (ACT S14).

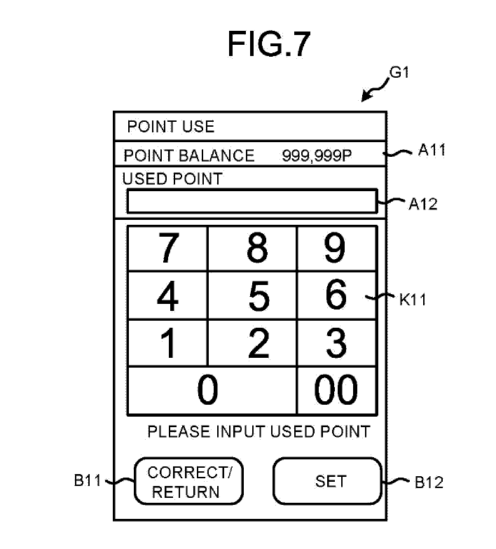

FIG. 7 is a diagram illustrating an example of the point use screen.

As shown in FIG. 7, the display control section 101 displays the point balance acquired in ACT S13 in an area A11 and displays numeric keys K11 for inputting the used point on the point use screen G1.

The point use screen G1 includes an area A12 for displaying the input numerical value.

The point use screen G1 further includes a button B11 for correcting the input numerical value and a button B12 for instructing the input completion.

After the used point is set through the operation on the numeric key K11, if the button B12 is operated, the point processing section 103 receives the input used point.

In a case in which “0” is set as the used point or in a case in which the button B11 is operated while no used point is input, “0” is received as the used point.

Return to FIG. 6. The point processing section 103 waits until the used point is input (NO in ACT S15).

If the input of the used point is received (YES in ACT S15), the settlement processing section 102 determines whether or not the input used point is lower than the point balance (ACT S16).

If the used point is greater than the point balance (NO in ACT S16), the point processing section 103 displays an error screen (not shown) indicating that the points cannot be used and then returns to ACT S14.

If it is determined in ACT S16 that the used point is lower than the point balance (YES in ACT S16), the point processing section 103 displays a confirmation screen asking for the confirmation of the used point on the display section 32 (ACT S17).

In a case in which the used point is “0”, the processing in ACT S21 is carried out directly without displaying the confirmation screen.

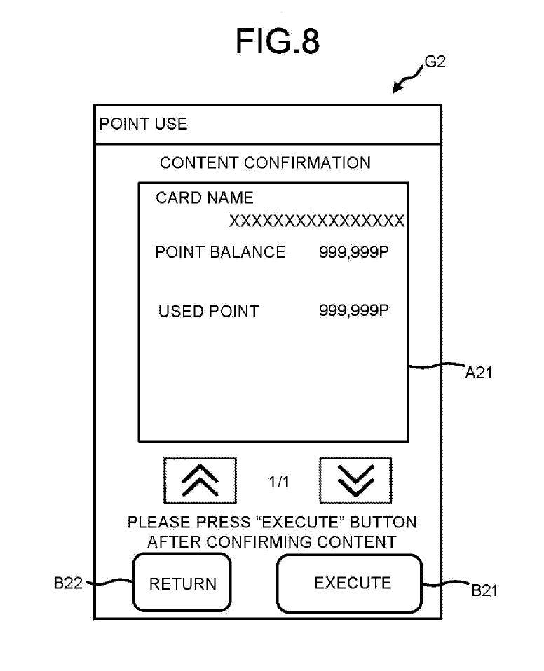

FIG. 8 is a diagram illustrating an example of the confirmation screen.

As shown in FIG. 8, the display control section 101 displays the card number (card name) read in ACT S11, the point balance acquired in ACT S13 and the used point input in ACT S15 in the area A21 on the confirmation screen G2.

The confirmation screen G2 includes a button B21 for instructing the use of points and a button B22 for instructing the re-input of the used point.

Return to FIG. 6. The point processing section 103 determines whether or not the use of points is instructed (ACT S18).

If the re-input of the used point is instructed (NO in ACT S18), the point processing section 103 returns to ACT S14 to display the point use screen.

On the other hand, in the ACT S18, if the use of points is instructed (YES in ACT S18), the point processing section 103 subtracts an amount corresponding to the used point from the payment amount to use the points (ACT S19).

The point processing section 103 instructs the subtraction of the used point together with the card number to the point management server 5 to subtract the used point from the point balance (ACT S20).

Next, the point processing section 103 displays a point granting screen for confirming whether or not to grant points on the display section 32 (ACT S21).

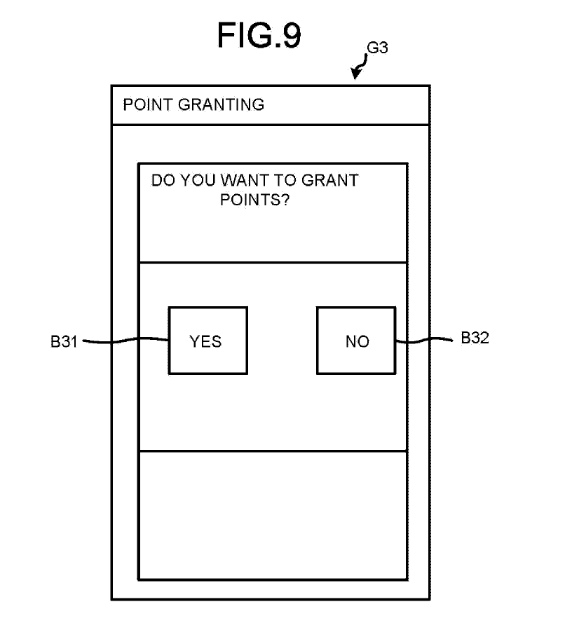

FIG. 9 is a diagram illustrating an example of the point granting screen.

As shown in FIG. 9, the display control section 101 displays a button 531 for instructing the granting of points and a button B32 for instructing not to grant points on the point granting screen G3.

If the button B31 is operated, the point processing section 103 determines that the granting of points is instructed.

If the button B32 is operated, the point processing section 103 determines that it is instructed not to grant points.

For example, in a case of carrying out settlement using a plurality of settlement methods in one transaction, points are granted in the first settlement method.

In this case, the button B32 is operated in the following settlement methods to prevent the repetition of point granting operation.

Alternatively, in a case in which the button B31 is operated for many times in one transaction, the point processing section 103 may display a confirmation screen indicating the possibility of repetition of point granting.

Return to FIG. 6. The point processing section 103 determines whether or not the granting of points is instructed (ACT S22).

If it is instructed not to grant points (NO in ACT S22), the point processing section 103 carries out the processing in ACT S25.

On the other hand, in ACT S22, if the granting of points is instructed (YES in ACT S22), the point processing section 103 calculates the added points to be granted based on the payment amount in the transaction and the point granting rate stored in the setting information 652 (ACT S23).

Herein, the added points are calculated based on the total payment amount in one transaction, and the standard is not changed even in a case in which the settlement is carried out for a plurality of times using a plurality of settlement methods.

Further, in a case in which the commodities purchased by the customer include a commodity for which no point should be granted, the points are calculated based on the payment amount excluding the amount of the commodity.

Next, the point processing section 103 sends the instruction information instructing the adding of the added point amount together with the card number to the point management server 5 to instruct the adding of the added points (ACT S24).

The payment amount serving as the basis of the added point calculation is the amount before the amount-subtraction based on the used point; however, it is not limited to this. For example, the payment amount serving as the basis of the added point calculation may be the amount after the amount-subtraction.

Next, the print control section 104 controls the printing section 67 to print the printing data including the used point used in ACT S19, the added points calculated in ACT S23 and the like (ACT S25), and then the present processing is terminated.

In a case in which neither the use of points nor the adding of points is carried out, the printing is not carried out.

As stated above, in accordance with the settlement terminal 3 of the present embodiment, the processing relating to the use and the granting of points is sequentially executed in the point processing having a series of screen transitions.

In this way, the operator of the settlement terminal 3 can sequentially executes the processing relating to the use and the granting of points in a series of operations without any switch operation on the switch button to switch between the use and the granting of points.

Particularly, the settlement terminal 3 is a settlement terminal for electronic settlement, thus, the operability thereof is limited compared with the POS terminal 2 provided with the keyboard 24 and the like.

Thus, in the settlement terminal 3, the operation of switching between the use and the granting of points is complicated and may hinder the work.

Thus, as stated above, in the settlement terminal 3 of the present embodiment, the processing relating to the use and the granting of points is sequentially executed in a series of operations.

In this way, the processing relating to the use and the granting of points can be carried out efficiently, which contributes to the facilitation of work.

While certain embodiments have been described, these embodiments have been presented by way of example only, and are not intended to limit the scope of the present invention. Indeed, the novel embodiments may be embodied in a variety of other forms; furthermore, various omissions, substitutions, variations and supplementations thereof may be devised without departing from the spirit of the present invention. The accompanying claims and their equivalents are intended to cover such forms and modifications as would fall within the scope and spirit of the present invention.

For example, in the embodiment described above, a card type storage medium such as a magnetic card, an IC card and the like is used; however, it is not limited to this. For example, it is applicable to read, using near field communication technology such as NFC and the like, information from an information machine such as a mobile phone or a smart phone and the like provided with a storage medium in which identification information instead of the card information and the settlement information is stored.

The control program 651 executed by the settlement terminal 3 of the embodiment described above is installed in the memory section 65 and the like in advance; however, it is not limited to this. The control program 651 executed by the settlement terminal 3 of the embodiment described above may be recorded in a computer-readable recording medium such as CD-ROM, flexible disk (FD), CD-R, DVD (Digital Versatile Disk) and the like in the form of installable or executable file.

Further, the control program 651 executed by the settlement terminal 3 of the embodiment described above may be stored in a computer connected with a network such as internet, and downloaded via the network. Further, the control program 651 executed by the settlement terminal 3 of the embodiment described above may also be provided or distributed via a network such as the Internet.

The control program 651 executed by the settlement terminal 3 of the embodiment described above is read and executed from the memory section 65 by the CPU 61 (processor) serving as a practical hardware having a module constitution including the foregoing each section (the display control section 101, the settlement processing section 102, the point processing section 103 and the print control section 104), in this way, the foregoing each section is loaded into the RAM 63 and generated in the RAM 63.

What is claimed is:

1. A settlement terminal comprising:
a reading module configured to read information stored in a storage medium held by a customer;
a settlement module configured to carry out settlement processing based on settlement information read by the reading module;
a point granting module configured to add points corresponding to a settlement amount to a cumulative value associated with the identification information read by the reading module, within point management data in which the identification information for identifying each storage medium and the cumulative value of points granted for the identification information are associated with each other, to grant the points;
a point use module configured to subtract the instructed point from the cumulative value associated with the identification information read by the reading module to use the points in a pre-determined service; and
a provision module configured to provide an operation screen for continuously executing the use and the granting of points in a series of operations.

2. The settlement terminal according to claim 1, wherein
the provision module provides a first operation screen for inputting points to be used; and
the point use module uses the points in a case in which points input in the first operation screen are lower than the cumulative value associated with the identification information read by the reading module.

3. The settlement terminal according to claim 1, wherein
the provision module provides a second operation screen for selecting whether or not to grant points; and
the point granting module grants the points in a case in which the point granting is selected in the second operation screen.

4. The settlement terminal according to claim 2, wherein
the provision module provides a second operation screen for selecting whether or not to grant points; and
the point granting module grants the points in a case in which the point granting is selected in the second operation screen.

5. The settlement terminal according to claim 1, wherein
the settlement module executes the settlement processing using a plurality of settlement methods for one transaction; and
the provision module provides the operation screen for each settlement method.

6. The settlement terminal according to claim 1, wherein
the reading module reads the settlement information and the identification information from the same or different storage mediums held by the customer.

7. A method for a settlement terminal, including:
reading information stored in a storage medium held by a customer;
carrying out settlement processing based on settlement information read by the reading module;
adding points corresponding to a settlement amount to a cumulative value associated with the identification information read by the reading module, within point management data in which the identification information for identifying each storage medium and the cumulative value of points granted for the identification information are associated with each other, to grant the points;
subtracting the instructed point from the cumulative value associated with the identification information read by the reading module to use the points in a pre-determined service; and
providing an operation screen for continuously executing the use and the granting of points in a series of operations.
